(19) United States
(12) Patent Application Publication
(10) Pub. No.: US 2010/0154959 A1
(43) Pub. Date: Jun. 24, 2010

(54) METHOD AND APPARATUS FOR BUILDING A TIRE HAVING A PUNCTURE SEALANT

(76) Inventors: Ramendra Nath Majumdar, Hudson, OH (US); Aaron Scott Puhala, Kent, OH (US); Patrick David Marks, Uniontown, OH (US)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 12/623,627

(22) Filed: Nov. 23, 2009

Related U.S. Application Data
(60) Provisional application No. 61/140,133, filed on Dec. 23, 2008.

(51) Int. Cl. B60C 19/12

(52) U.S. Cl. 152/504

(57) ABSTRACT

A tire with a built in sealant comprising: sidewalls, a supporting tire carcass comprised of one or more layers of ply, a pair of beads, and an outer circumferential tread, wherein the sidewalls extend radially inward from the axial outer edges of the tread portion to join the respective beads, and a layer of sealant disposed between the inner liner and a cover layer, the carcass of the tire has a radially innermost layer, wherein the sealant is located over said gas permeable liner, and has a first outer edge and a second outer edge, wherein on each side of said sealant adjoining with the first outer edge and the second outer edge is two or more layers of butyl rubber inner liner.

This application claims the benefit of and incorporates by reference U.S. Provisional Application No. 61/140,133 filed Dec. 23, 2008.

### TECHNICAL FIELD

This invention relates to a method and apparatus for making a tire having a puncture sealant.

### BACKGROUND OF THE INVENTION

It is known in the prior art to apply puncture sealants made of puncture sealing rubber or plastic material on the crown portion of the tire so that when a sharp object such as a nail pierces the tire, the tire sealant forms a seal around the puncture. Tire sealants of this nature tend to be rather thick, and having a thickness on the order of about four to six times the thickness of a typical innerliner. Thus as shown in FIG. 1, additional layers of inner liner 20 are used to hold the sealant 7 in place. These extra layers of inner liner add cost and weight to the tire, and may additionally contribute to heat build up. Thus an improved construction of a tire having a sealant layer is desired.

### Definitions

“Aspect Ratio” means the ratio of a tire's section height to its section width.

“Axial” and “axially” mean the lines or directions that are parallel to the axis of rotation of the tire.

“Carcass” means a laminate of tire ply material and other tire components cut to length suitable for splicing, or already spliced, into a cylindrical or toroidal shape. Additional components may be added to the carcass prior to its being vulcanized to create the molded tire.

“Circumferential” means lines or directions extending along the perimeter of the surface of the annular tread perpendicular to the axial direction; it can also refer to the direction of the sets of adjacent circular curves whose radii define the axial curvature of the tread as viewed in cross section.

“Cord” means one of the reinforcement strands, including fibers, which are used to reinforce the plies.

“Inner Liner” means the layer or layers of elastomer or other material that form the inside surface of a tubeless tire and that contain the inflating fluid within the tire.

“Ply” means a cord-reinforced layer of elastomer-coated, radially deployed or otherwise parallel cords.

“Radial” and “radially” mean directions radially toward or away from the axis of rotation of the tire.

“Radial Ply Structure” means the one or more carcass plies or which at least one ply has reinforcing cords oriented at an angle of between 65° and 90° with respect to the equatorial plane of the tire.

“Radial Ply Tire” means a belted or circumferentially-restricted pneumatic tire in which the ply cords which extend from bead to bead are laid at cord angles between 65° and 90° with respect to the equatorial plane of the tire.

“Sidewall” means a portion of a tire between the tread and the bead.

“Skive” or “skive angle” refers to the cutting angle of a knife with respect to the material being cut; the skive angle is measured with respect to the plane of the flat material being cut.

“Laminate structure” means an unvulcanized structure made of one or more layers of tire or elastomer components such as the innerliner, sidewalls, and optional ply layer.

### BRIEF DESCRIPTION OF THE DRAWINGS

The structure, operation, and advantage of the invention will become further apparent upon consideration of the following description taken in conjunction with the accompanying drawings wherein:

FIG. 1 is a prior art simplified schematic view of a cross section of a laminate containing the sealant layer;

FIG. 2 is a cross sectional view of the laminate containing the sealant of the present invention; and

FIG. 3 is a cross sectional view of a cured tire with barrier of the present invention.

### DETAILED DESCRIPTION OF THE INVENTION

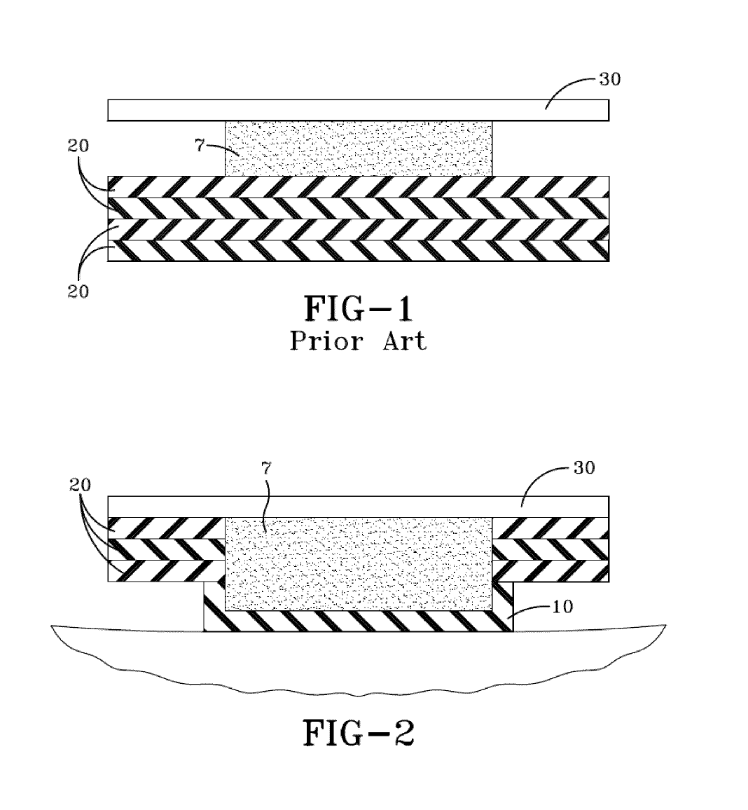

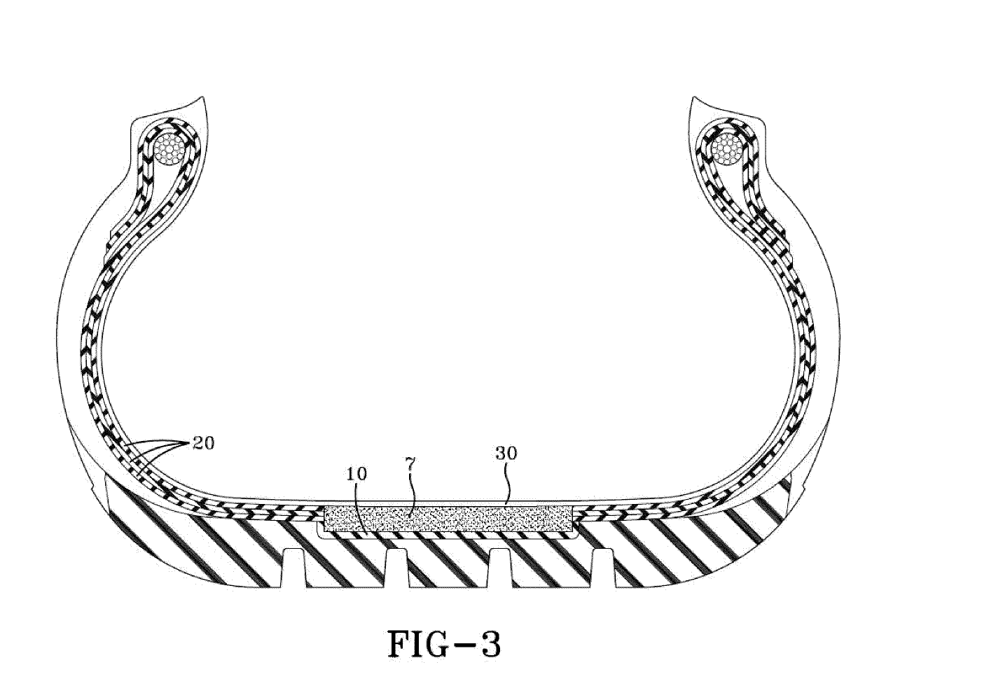

Referring now to FIG. 1, there is illustrated a cross-sectional view of a laminate containing a sealant layer to form a self-sealing pneumatic tire. The tire (not shown) may be any type of tire, such as a truck tire, a light truck tire or a passenger tire. The tire (not shown) includes sidewalls, a supporting tire carcass, a pair of beads, and an outer circumferential tread. The sidewalls extend radially inward from the axial outer edges of the tread portion to join the respective beads. The carcass acts as a support structure for the tread and sidewalls, and is comprised of one or more layers of ply.

As shown in FIG. 2, the carcass of the tire of the present invention has a radially innermost protective layer 10 to prevent contamination of tire curing bladder with sealant material which is generally semi-solid. This protective layer may be made of a butyl rubber or of a general purpose rubber because barrier properties are not needed for this layer. The layer may also be porous material like non-woven which will prevent blister formation from trapped gases generated during sealant precursor degradation. Next, a built in sealant layer 7 is applied on top of or radially outward of the protective layer 10. The sealant layer 7 may have a width less than the width of the squeegee 30. On each side of the sealant layer 7, two to three layers of inner liner 20 made of butyl rubber are applied. A layer of squeegee 30 is applied over the inner liner and the sealant layer.

The advantage to the above described tire construction is the saving in butyl rubber. The sealant layer is utilized to provide the needed barrier properties due to its butyl rubber composition. Thus, excess inner liner is eliminated, resulting in reduced tire weight, a cheaper tire and reduced tire heat generation.

### Sealant Composition

The sealant 7 may include any suitable sealant composition with barrier properties, known to those skilled in the art, such as rubber or elastomer compositions and plastic compositions. One suitable polymer composition suitable for use is described in U.S. Pat. No. 4,895,610, the entirety of which is incorporated by reference. The polymer compositions described therein include the following composition by weight: 100 parts of a butyl rubber copolymer, about 10 to about 40 parts of carbon black, about 5 to about 35 parts of an oil extender, and from about 1 to 8 parts of a peroxide vulcanizing agent. A second polymer composition includes the following composition by weight: 100 parts of a butyl rubber copolymer, about 20 to about 30 parts of carbon black, about 8 to about 12 parts of an oil extender, and from about 2 to 4 parts of a peroxide vulcanizing agent.

The sealant 7 may also comprise a colored polymer composition as described in U.S. Pat. No. 7,073,550, the entirety of which is incorporated herein by reference. The colored polymer composition is comprised of, based upon parts by weight per 100 parts by weight of said partially depolymerized butyl rubber exclusive of carbon black:
(A) a partially organoperoxide-depolymerized butyl rubber as a copolymer of isobutylene and isoprene, wherein said butyl rubber, prior to such depolymerization, is comprised of about 0.5 to about 5, preferably within a range of from 0.5 to one, percent units derived from isoprene, and correspondingly from about 95 to about 99.5, preferably within a range of from 99 to 99.5, weight percent units derived from isobutylene;
(B) particulate reinforcing filler comprised of:
   (1) about 20 to about 50 phr of synthetic amorphous silica, preferably precipitated silica, or
   (2) about 15 to about 30 phr synthetic amorphous silica, preferably precipitated silica, and about 5 to about 20 phr of clay, preferably kaolin clay, or
   (3) about 15 to about 30 phr synthetic amorphous silica, preferably precipitated silica, and about 5 to about 20 phr of calcium carbonate,
   (4) about 15 to about 30 phr synthetic amorphous silica, preferably precipitated silica, about 5 to about 15 phr of clay, preferably kaolin clay, and about 5 to about 15 phr of calcium carbonate;
(C) from zero to 6, alternately about 0.5 to about 5, phr of short organic fibers
(D) a colorant of other than a black color wherein said colorant is selected from at least one of organic pigments, inorganic pigments and dyes, preferably from organic pigments and inorganic pigments;
(E) from zero to about 20, alternately about 2 to about 15, phr of rubber processing oil, preferably a rubber processing oil having a maximum aromatic content of about 15 weight percent, and preferably a naphthenic content in a range of from about 35 to about 45 weight percent and preferably a paraffinic content in a range of about 45 to about 55 weight percent.

Another sealant polymer composition which may be utilized by the invention is described in U.S. Pat. No. 6,837,287, the entirety of which is hereby incorporated by reference.

Further, any sealant polymer composition may also be used with the invention that has a polymer composition with air barrier properties.

The thickness of the sealant can vary greatly in an unvulcanized puncture sealant-containing tire. Generally, the thickness of the sealant composition layer may range from about 0.13 cm (0.05 inches) to about 1.9 cm (0.75 inches). In passenger and truck tires it is normally desired for the sealant composition layer to have a thickness of about 0.32 cm (0.125 inches) to about 0.62 cm (0.25 inches). The sealant width may vary depending upon the tire size, but may typically be in the range of about 3 to 6 inches.

After the unvulcanized pneumatic rubber tires of this invention are assembled they are vulcanized using a normal tire cure cycle. The tires of this invention can be cured over a wide temperature range depending somewhat upon the size of the tire and the degree of desired depolymerization of the butyl rubber as well as the thickness of the sealant layer itself and sufficient to at least partially depolymerize said sealant precursor layer.

### EXAMPLE 1

A 1.6 mm thick sealant precursor compound was obtained. Its barrier properties were measured using Mocon and is shown in Table 1. Then the compound was heated for 23 minutes at 150 C and barrier properties after sealant formation was again determined and shown in column 2 of Table 1. Barrier properties of a typical bromobutyl based rubber of thickness 40 mil is also shown in Table 1.

TABLE 1
Comparison of barrier properties of a bromobutyl
based innerliner with that of sealant compound

| | G1999 | G1999 | Bromobutyl |
|---|---|---|---|
| | (as received) | (23 min/150 C.) | Tire Liner |
| Thickness (mm) | 1.61 | 2.6 | 1 |
| Transmission Rate cc/ | 37 | 33 | 80 |
| [m2-day] | | | |
| Permeation Rate cc-mm/ | 60 | 85 | 80 |
| [m2-day] | | | |

Table 1 shows that barrier properties of G1999 sealant in equivalent thickness which is similar to bromobutyl liner. Thus four layers of innerliner on top of a thick built-in sealant (G1999) layer excessive barrier in the crown area of tire. The novel laminate design is proposed to eliminate redundant materials from tires with built-in sealant.

While certain representative embodiments and details have been shown for the purpose of illustrating the invention, it will be appreciated there is still in the art various changes and modifications may be made therein without departing from the spirit or scope of the invention.

What is claimed is:

1. A tire with a built in sealant comprising: sidewalls, a supporting tire carcass comprised of one or more layers of ply, a pair of beads, and an outer circumferential tread, wherein the sidewalls extend radially inward from the axial outer edges of the tread portion to join the respective beads, and a layer of sealant disposed between the inner liner and a cover layer, the carcass of the tire has a radially innermost layer, wherein the sealant is located over a protective layer, and has a first outer edge and a second outer edge, wherein on each side of said sealant adjoining with the first outer edge and the second outer edge is two or more times thicker than the protective layer.

2. The tire of claim 1 wherein a thin layer of squeegee is applied over the inner liner and the sealant layer.

3. The method of claim 1 wherein the sealant has a width in the range of about 6 to about 10 inches.

4. The method of claim 1 wherein the sealant is colored.

5. The method of claim 1 wherein the sealant is comprised of, based upon parts by weight per 100 parts by weight of said partially depolymerized butyl rubber exclusive of carbon black:
(A) a partially organoperoxide-depolymerized butyl rubber as a copolymer of isobutylene and isoprene, wherein said butyl rubber, prior to such depolymerization, is comprised of about 0.5 to about 5 percent units derived from isoprene, and correspondingly from about 95 to about 99.5 weight percent units derived from isobutylene;
(B) particulate reinforcing filler comprised of:
(1) about 20 to about 50 phr of synthetic amorphous silica, or
(2) about 15 to about 30 phr synthetic amorphous silica, preferably precipitated silica, and about 5 to about 20 phr of clay, or
(3) about 15 to about 30 phr synthetic amorphous silica and about 5 to about 20 phr of calcium carbonate, or
(4) about 15 to about 30 phr synthetic amorphous silica, about 5 to about 15 phr of clay and about 5 to about 15 phr of calcium carbonate;
(C) from zero to 6 phr of short organic fibers;
(D) a colorant of other than a black color wherein said colorant is selected from at least one of organic pigments, inorganic pigments and dyes; and
(F) from zero to about 20 phr of rubber processing oil.
